(19) United States
(12) Patent Application Publication
(10) Pub. No.: US 2008/0011662 A1
(43) Pub. Date: Jan. 17, 2008

(54) Compositions and methods for fluid purification

(76) Inventors: Emil Milosavljevic, Reno, NV (US); Roger Eric Johnson, Reno, NV (US)

Correspondence Address: KIRKPATRICK & LOCKHART PRESTON GATES ELLIS LLP, 535 SMITHFIELD STREET, PITTSBURGH, PA, 15222, US

(21) Appl. No.: 11/823,804

(22) Filed: Jun. 28, 2007

Related U.S. Application Data
(63) Continuation-in-part of application No. 11/540,498, filed on Sep. 29, 2006.
(60) Provisional application No. 60/793,344, filed on Apr. 20, 2006.
(60) Provisional application No. 60/796,020, filed on Apr. 28, 2006.

(51) Int. Cl. B01D 15/00; B01D 53/02; B01D 24/00

(52) U.S. Cl. 210/284; 210/290; 96/132

(57) ABSTRACT

A multi-barrier filter comprising a halogenated resin capable of removing contaminants from a fluid, and at least one contaminant sorbent medium downstream of the halogenated resin capable of adsorbing or absorbing contaminants. The at least one contaminant sorbent medium is preferably “halogen-neutral” to maximize the antimicrobial effectiveness of the halogen in the fluid. The filter may comprise at least one “halogen-scavenger” barrier downstream of the halogen-neutral barrier. Because of the efficiency of the filter, a low-residual halogenated resin, such as, for example, low residual iodinated resin, may be used.

### CROSS-REFERENCE TO RELATED APPLICATIONS

This application is a continuation-in-part of prior U.S. patent application Ser. No. 11/540,498, filed Sep. 29, 2006, which claims the benefit under 35 U.S.C. §119(e) of U.S. Provisional Application No. 60/793,344, filed on Apr. 20, 2006, and U.S. Provisional Application No. 60/796,020, filed on Apr. 28, 2006, where these three applications are incorporated herein by reference in their entirety.

### BACKGROUND OF THE INVENTION

1. Field of the Invention

The present invention generally relates to media and apparatuses for removing contaminants from a fluid as well as methods of making and using the same.

2. Description of the Related Art

Purification or removal of contaminants from aqueous and/or gaseous solutions is necessary for a variety of reasons. For example, purified air and/or water may be necessary for the general health of a population; for emergency use during natural disasters or terrorist threats or attacks; for recreational use (such as for hiking or camping); for biotechnology related applications; for hospital and dental offices; for laboratory “clean rooms” and for manufacturing of semiconductor materials. In addition, industrial pollutants, microbes and other debris or infectious agents pose a critical health risk if not removed from the air or drinking water, especially in a vulnerable population such as children, the elderly or those afflicted with disease.

Over 97% of all fresh water on earth is groundwater, and billions of people rely on groundwater as their only source of water. Worldwide, over one billion people lack access to sufficient quantities of clean water to survive. As a result, at least ten million people die each year from waterborne diseases, and at least two million of those people are young children. It is well known that pathogenic organisms thrive in untreated and unsanitary water. While historically it was thought that groundwater was relatively pure due to the percolation through the topsoil, research on testing various groundwater sources has revealed that up to 50% of the active groundwater sites in America are positive for Cryptosporidium, Giardia, or both. Furthermore, viruses are able to survive longer and travel farther than bacteria when disposed in a groundwater source, in part due to their small size and colloidal physicochemical properties. (Azadpour-Keeley, et al., EPA Groundwater Issue, 2003, hereby incorporated by reference in its entirety). While bacterial analysis has occurred for many years, viral indicators for groundwater have only recently been established. In the past, there were many misconceptions regarding viruses in groundwater, including that viruses were not normal flora of an animal's intestinal tract and thus were only excreted by infected individuals; there was an overall lack of detection of viral indicators; it was thought that viruses were only able to exist and multiply within living susceptible cells; and ingestion by a community of low levels of viruses would not be harmful. Some of the more important factors affecting virus transport include soil water content, temperature, sorption and desorption in the soil, pH, salt content, type of virus and hydraulic stresses. It is also now suspected that in general, viruses are adsorbed onto solid surfaces such as suspended solids and sediment, which allows them to remain active for great lengths of time. (Sakoda, et al., Wat Sci. Tech., 35, 7, pp. 107-114, 1997, hereby incorporated by reference in its entirety). The U.S. Environmental Protection Agency has established maximum contaminant level goals (MCLGs) for pathogenic microorganisms in drinking water, which include a setting of zero for viruses, as of 2002. Thus, removing contaminants, especially viruses, from water supplies is a critical health issue.

The U.S. Environmental Protection Agency Science Advisory Board ranks contaminated drinking water as one of the public's greatest health risks. Waterborne contaminants include viruses, such as enteroviruses (polio, Coxsackie, echovirus, hepatitis), rotaviruses and other reoviruses, adenoviruses Norwalk-type agents, other microbes including fungi (including molds), bacteria (including salmonella, shigella, yersinia, mycobacteria, enterocolitica, E. coli, Campylobacter, Legionella, Cholera), flagellates, amoebae, Cryptosporidium, Giardia, other protozoa, prions, proteins and nucleic acids, pesticides and other agrochemicals including organic chemicals, inorganic chemicals, halogenated organic chemicals and other debris.

Standard point-of-entry(POE) and point-of-use(POU) filtration systems have been based largely on chemical oxidation, such as ozone treatment, and/or ultraviolet light treatment and/or membrane filtration such as microfiltration and/or ultrafiltration and/or reverse osmosis. However, these systems are expensive and cannot always be easily converted to handle small amounts of gas, vapor or liquid (such as for a single user), as well as large quantities (enough for a small village or community). In addition, unclean storage facilities may contaminate the water after previous removal of impurities. Some examples of existing filters are discussed in U.S. Pat. Nos. 4,298,475 and 4,995,976.

Thus, there remains a need in the art for a filter media to remove contaminants from gas, vapor and/or liquid solutions. Further, there remains a need in the art for methods for removing contaminants, or purifying solutions as well as for apparatuses that provide high-performance purification.

### BRIEF SUMMARY OF THE INVENTION

The present invention relates to a “multi-barer” filter medium, apparatus and system for removing contaminants from a fluid. The present invention is based on, among other things, the surprising synergistic result of combining one or more halogenated resins and one or more contaminant sorbent media. For example, the combination of a halogenated resin with a contaminant sorbent media results in consistently higher efficiency for removal of common contaminants, including bacteria and viruses, as well as allows for a substantial increase in the volume of fluid that can be purified compared to any single filter media alone. In addition, another advantage afforded by one aspect of the present invention includes a significantly higher flow rate per unit area than with conventional single-filter systems or devices.

In another embodiment, at least one “halogen-neutral barrier” may be employed downstream of the halogenated resin, which may not adsorb, absorb, or convert halogens to their ionic form, or, which may adsorb, absorb, or convert halogens to their ionic form to a lesser degree than a reference material or standard. In one embodiment, this may allow the halogens to remain in the fluid for a longer period of time before removal or before the fluid exits the filter, which may improve the antimicrobial activity of the halogens. The halogens may be removed downstream from the at least one halogen-neutral barrier by at least one “halogen-scavenger barrier.” In another embodiment, because of the higher efficiency of the multi-barrier filter, low residual halogenated resins may be used, possibly requiring reduced removal by the halogen-scavenger barriers, or, if halogen levels are low enough to be safe and have an acceptable taste and yet high enough for sufficient antimicrobial activity, the halogens may remain in the fluid until it exits the filter.

Another advantage of one aspect of the present invention is that the combination of a halogenated resin and a contaminant sorbent media renders contaminants harmless, and very little, if any, elution of the contaminants from the filters ever occurs. As a result, the spent filter media may be disposed of safely in a landfill. For example, traditional fluid filters or purification systems may have contaminants stripped or eluted from the filters at high pH levels and/or temperature changes. When this occurs, the effluent fluid may contain a higher concentration of contaminants than the influent fluid. However, under high pH conditions halogenated resins, including iodinated resins, produce higher levels of halogens which render harmless common contaminants, including bacteria and viruses.

Another advantage of one aspect of the present invention includes continual anti-microbicide agents via the halogenated resins during prolonged periods of nonuse. Since the halogenated resin continuously produce halogens, these halogens reach the surface of the filter and act as antimicrobial agents, preventing microbial growth if the fluid purification system is not in use for an extended period of time. Along these same lines, the characteristics of the “multi-barrier” filter media allow for prolonged contact of the halogenated resin with the fluid to be purified, thus increasing the efficiency of microbial kill and disarmament. In addition, the surprising synergy of the combination of one or more contaminant sorbent media with one or more halogenated resins allows for the use of smaller components of both, especially in portable systems, which reduces the overall cost.

Still another advantage of one embodiment includes simplicity of design and ease of manufacture since the usual length-to-diameter ratios (such as >3 for a Microbial Check Valve® column) are unnecessary due to the “multi-barrier” fluid media.

Finally, due to the high efficiency of the “multi-barrier” fluid purification system, low residual halogenated resins may be used, which allows for less free halogenated species to be removed before dispensing the purified fluid. Indeed, it may even be possible to allow the halogens to remain in the fluid if the levels are high enough for adequate microbial kill but low enough to result in safe levels of halogens in the fluid and an aesthetically pleasing taste and/or scent of the purified fluid.

The “multi-barrier” filter media, apparatuses, and systems of the present invention may be implemented by combining the media components and functions in a single unit or device, or by using several separate devices in series or in parallel, with each device performing a distinct function.

Various embodiments of a multi-barrier filter are disclosed. In some embodiments, the filter comprises a halogenated resin capable of removing contaminants from a fluid, and at least one contaminant sorbent medium downstream of the halogenated resin capable of adsorbing or absorbing contaminants. In certain embodiments, the at least one contaminant sorbent medium may have an iodine number less than 300 mg/g.

Other embodiments of the present disclosure include a filter apparatus for removing contaminants from a fluid. The filter apparatus may comprise a housing comprising one or more inlet ports and one or more outlet ports, a halogenated resin capable of removing contaminants, and at least one contaminant sorbent medium downstream of the halogenated resin capable of adsorbing or absorbing contaminants. In certain embodiments, the at least one contaminant sorbent medium has an iodine number less than 300 mg/g.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements or angles are not drawn to scale, and some of these elements are arbitrarily enlarged and positioned to improve drawing legibility. Further, the particular shapes of the elements as drawn are not intended to convey any information regarding the actual shape of the particular elements and have been solely selected for ease of recognition in the drawings.

FIG. 1 is a cross-sectional view of a fluid purification device in a “drinking straw” style, according to one illustrated embodiment.

FIG. 2 is a cross-sectional view of a self-contained fluid purification device in a housing, according to one illustrated embodiment.

FIG. 3 is a schematic of a fluid purification system utilizing stored water as the fluid source, according to one illustrated embodiment.

FIG. 4 is a schematic of a fluid purification system utilizing running water as the fluid source, according to one illustrated embodiment.

FIG. 5 is a flowchart showing a method of using a fluid purification apparatus to remove contaminants from at least one fluid, according to one illustrated embodiment.

FIG. 6 is a schematic of a fluid purification system wherein two separate filter media components are in series, according to one illustrated embodiment.

FIG. 7 is a cross-sectional view of a self-contained fluid purification apparatus according to one illustrated embodiment that may include a smaller scale “drinking straw” style, or a larger scale purification device.

### DETAILED DESCRIPTION OF THE INVENTION

Overview

In the following description, certain specific details are set forth in order to provide a thorough understanding of various embodiments of the invention. However, one skilled in the art will understand that the invention may be practiced without these details. In other instances, well-known structures and methods associated with aqueous or gaseous filtration or purification devices and/or systems and methods of using and making the same may not be shown or described in detail to avoid unnecessarily obscuring descriptions of the embodiments of the invention.

Unless the context requires otherwise, throughout the specification and claims which follow the word “comprise” and variations thereof, such as “comprises” and “comprising,” are to be construed in an open, inclusive sense, that is, as “including, but not limited to.”

The headings provided herein are for convenience only and do not interpret or limit the scope or meaning of the claimed invention in any manner.

The present invention generally relates to a filter medium comprising one or more halogenated resins and one or more contaminant sorbent media. The one or more contaminant sorbent media may be any appropriate material that absorbs or adsorbs any contaminant from the selected gaseous, aqueous or vapor fluid.

The present invention generally relates to removing contaminants from a fluid. One of skill in the art would readily recognize that a fluid may comprise a gas (such as air), a vapor (such as humidity mixed with air), a liquid (such as water), or any combination thereof. In addition to these examples, other fluids are also considered by the present invention. For example, the fluid to be purified may be a bodily fluid (such as blood, lymph, urine, etc.), water in rivers, lakes, streams or the like, standing water or runoff, seawater, water for swimming pools or hot tubs, water or air for consumption in public locations (such as hotels, restaurants, aircraft or spacecraft, ships, trains, schools, hospitals, etc.), water or air for consumption in private locations (such as homes, apartment complexes, etc.), water for use in manufacturing computer or other sensitive components (such as silicon wafers), water for use in biological labs or fermentation labs, water or air for use in plant-growing operations (such as hydroponic or other greenhouses), wastewater treatment facilities (such as from mining, smelting, chemical manufacturing, dry cleaning or other industrial waste), or any other fluid that is desired to be purified.

In certain aspects, the invention includes filter media partnered with a high-efficiency particulate filter (HEPA) for air purification and use as a respirator, air cleaner in an industrial or residential setting, or other application.

Definitions

The terms used in this specification generally have their ordinary meanings in the art, within the context of this invention and in the specific context where each term is used. Certain terms are discussed below or elsewhere in the specification to provide additional guidance to the practitioner in describing the compositions and methods of the invention and how to make and use them. The scope and meaning of any use of a term will be apparent from the specific context in which the term is used. As such, the definitions set forth herein are intended to provide illustrative guidance in ascertaining particular embodiments of the invention, without limitation to particular compositions or biological systems. As used in the present invention and claims, the singular forms “a,” “an,” and “the” include plural forms unless the context clearly dictates otherwise.

Any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

The present disclosure describes several different features and aspects of the invention with reference to various exemplary embodiments. It is understood, however, that the invention embraces numerous alternative embodiments, which may be accomplished by combining any of the different features, aspects, and embodiments described herein in any combination that one of ordinary skill in the art would find useful.

“About” and “approximately,” as used herein, generally refer to an acceptable degree of error for the quantity measured, given the nature or precision of the measurements. Typical exemplary degrees of error may be within 20%, 10%, or 5% of a given value or range of values. Alternatively, and particularly in biological systems, the terms “about” and “approximately” may mean values that are within an order of magnitude, potentially within 5-fold or 2-fold of a given value. Numerical quantities given herein are approximate unless stated otherwise, meaning that the term “about” or “approximately” may be inferred when not expressly stated.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of less than or equal to 10.

As generally used herein, “contaminant” may refer to any undesirable agent in a gas, vapor, or liquid fluid or solution. “Contaminant” may include, for example, but not limited to, heavy metals, such as lead, nickel, mercury, copper, etc.; polyaromatics; halogenated polyaromatics; minerals; vitamins; microorganisms or microbes (as well as reproductive forms of microorganisms, including cysts and spores) including viruses, such as enteroviruses (polio, Coxsackie, echovirus, hepatitis, calcivirus, astrovirus), rotaviruses and other reoviruses, adenoviruses Norwalk-type agents, Snow Mountain agent, fungi (for example, molds and yeasts); helminthes; bacteria (including salmonella, shigella, yersinia, fecal coliforms, mycobacteria, enterocolitica, E. coli, Campylobacter, Serratia, Streptococcus, Legionella, Cholera); flagellates; amoebae; Cryptosporidium, Giardia, other protozoa; prions; proteins and nucleic acids; pesticides and other agrochemicals including organic chemicals (such as acrylamide, alachlor, atrazine, benzene, benzopyrene, carbfuran, carbon tetrachloride, chlordane, chlorobenzene, 2,4-D, dalapon, diquat, o-dichlorobenzene, p-dichlorobenzene, 1,2-dichloroethane, 1,1-dichloroethylene, cis-1,2-dichloroethylene); inorganic chemicals (such as antimony, arsenic, asbestos, barium, beryllium, cadmium, chromium, copper, cyanide, fluoride, lead, mercury, nitrate, selenium, thalium, dichloropropane, 1,2-dichloropropane, di(2-ethylhexyl)adipate, di(2-ethylhexyl)phthalate, dinoseb, dioxin, 1,2-diobromo-3-chloropropane, endothall, endrin, epichlorohydrin, ethylbenzene, ethylene dibromide, heptachlor, heptachlor epoxide, hexachlorobenzene, hexachlorocyclopentadiene, lindane, methoxychlor, oxamyl, polychlorinated biphenyls, pentachlorophenol, picloram, simazine, tetrachloroethylene, toluene, toxaphene, 2,4,5-TP, 1,2,4-trichlorobenzene, 1,1,1-trichloroethane, 1,1,2-trichloroethane, trichloroethylene, vinyl chloride, xylenes); halogenated organic chemicals; radioactive isotopes; and certain polyvalent dissolved salts; as well as other debris.

As generally used herein, “log reduction value” refers to the log₁₀ of the level of contaminants (typically the number of microorganisms) in the influent fluid divided by the level of contaminants (typically the number of microorganisms) in the effluent fluid of the filter media encompassed by the present invention. For example, a log 4 reduction in contaminants is >99.99% reduction in contaminants, whereas a log 5 reduction in contaminants is >99.999% reduction in contaminants. In at least one embodiment, the present invention includes methods and apparatuses or systems that may indicate at least a log 4 to log 5, log 5 to log 6, or log 6 to log 7 kill or removal of most microorganisms, potentially including viruses. In at least one embodiment, the present invention may indicate at least a log 7 to log 8 kill or removal of most microorganisms, potentially including viruses. In at least one embodiment, the present invention may indicate at least a log 8 to log 9 kill or removal of most microorganisms, potentially including viruses.

As generally used herein, “removing contaminants” or “reducing contaminants” refers to disarming one or more contaminants in the fluid, whether by physically or chemically removing, reducing, inactivating the contaminants or otherwise rendering the one or more contaminants harmless. In addition, the present disclosure further envisions certain aspects wherein particular embodiments include removing one or more contaminants but specifically excludes one or more types, groups, categories or specifically identified contaminants as well. For example, in certain aspects, “removing contaminants” may include one or more contaminants, or may include only one particular contaminant, or may specifically exclude one or more contaminants.

As generally used herein, “sorbent media” refers to material that may absorb or adsorb at least one contaminant. In general, “absorbent” includes materials capable of drawing substances, including contaminants, into its surface or structure, whereas “adsorbent” includes materials that are capable of physically holding substances, including contaminants, on its outer surface, potentially by Van der Waal's forces.

In certain aspects, one or more of the filter media components may be immobilized utilizing binders, matrices or other materials that hold the media components together. Some examples of binders and/or matrices include but are not limited to powdered polyethylene, end-capped polyacetals, acrylic polymers, fluorocarbon polymers, perfluorinated ethylene-propylene copolymers, ethylene-tetrafluoroethylene copolymers, polyamides, polyvinyl fluoride, polyaramides, polyaryl sulfones, polycarbonates, polyesters, polyaryl sulfides, polyolefins, polystyrenes, polymeric microfibers of polypropylene, cellulose, nylon, or any combination thereof. Some of these examples may be found in U.S. Pat. Nos. 4,828,698 and 6,959,820, both of which are hereby incorporated by reference in their entireties.

Contaminant Sorbent Media

The present invention relates to filter media, apparatuses, systems and kits that comprise one or more contaminant sorbent media and one or more halogenated resins. In certain embodiments, the invention relates to one, two, three, four, five, six, seven, eight, nine, ten, twelve, fifteen, twenty, fifty, one hundred or more contaminant sorbent media. In certain aspects, if more than one contaminant sorbent media is included, the same or multiple different contaminant sorbent media are considered for each one. In certain aspects, if more than one contaminant sorbent media is included, some media may be the same and others may be different. Multiple contaminant sorbent media may be physically or chemically separated from each other, or they may be physically or chemically joined with each other. Accordingly, the filter media may have multiple layers, some with the same media and others with different contaminant sorbent media utilized.

In certain embodiments, the present disclosure provides the use of barriers which do not adsorb or absorb halogens, or react with or provide catalytic reaction sites for the conversion of halogens to an ionic form. In some embodiments, barriers may adsorb fewer, absorb fewer, or convert fewer halogens to ionic form relative to another material or standard. One such standard is an “iodine number.” As used herein, the iodine number refers to the amount (in milligrams) of iodine adsorbed by one gram of a sorbent material. Materials that exhibit minimal or reduced adsorption, absorption, and ionic conversion of halogens are hereinafter collectively referred to as “halogen-neutral barriers.” Halogens that become adsorbed or absorbed or are converted to an ionic form may have reduced antimicrobial action or may become ineffective altogether. By allowing more halogens to remain in the fluid through the halogen-neutral barriers, the halogens may act more effectively as antimicrobial agents in the multi-barrier filter. The characteristics of the “multi-barrier” filter media allow for prolonged contact of the halogens with the fluid to be purified, thus potentially increasing the efficiency of microbial kill and disarmament. This may lead to increased flow rates and a broader range of filtration conditions, such as, for example, pH. In addition, the surprising synergy of the combination of one or more contaminant sorbent media with one or more halogenated resins allows for the use of smaller amounts of both components, especially in portable systems, and may reduce the overall cost. Also, due to the increased efficiency of multi-barrier fluid purification systems set forth herein, the amount of halogens required in the fluid may be reduced, which, in turn, may allow for the use of low residual halogenated resins.

In certain embodiments of the present disclosure, halogen-neutral contaminant sorbent media, which may be at least partially defined by iodine number, may be provided. In one embodiment, a halogen-neutral barrier of the present disclosure may comprise a contaminant sorbent medium with an iodine number less than 600 mg/g. In another embodiment, a halogen-neutral barrier may comprise a contaminant sorbent medium with an iodine number less than 300 mg/g. In yet another embodiment, a halogen-neutral barrier may comprise a contaminant sorbent medium with an iodine number less than 200 mg/g. In still another embodiment, a halogen-neutral barrier may comprise a contaminant sorbent medium with an iodine number from 100 to 200mg/g. In another embodiment, a halogen-neutral barrier may comprise a contaminant sorbent medium with an iodine number from 0 to 100 mg/g. In still another embodiment, a halogen-neutral barrier may comprise a contaminant sorbent medium with an iodine number from 0 to 50 mg/g. In another embodiment, a halogen-neutral barrier may comprise a contaminant sorbent medium with an iodine number from 0 to 10 mg/g. In still another embodiment, a halogen-neutral barrier may comprise a contaminant sorbent medium with an iodine number of about 0 mg/g.

Since halogens, and particularly chlorine and iodine, function efficiently as antimicrobial agents, it is desirable to include one or more halogenated resins in fluid purification media. However, most halogens impart an unsavory flavor to the fluid, and it is desirable to remove substantially all of the halogen once the microbes have been eliminated. In some instances, it may be desirable to retain a small amount of one or more halogens in the fluid in order to retard or inhibit microbial growth during storage, transport and/or dispensing of the fluid.

In certain other embodiments, it may be necessary to use barriers that absorb or adsorb halogens or react with or provide catalytic reaction sites for the conversion of halogens to an ionic form in order to improve smell, taste, or to make the fluid suitable for drinking. In certain other embodiments, it may be necessary to use barriers that absorb or adsorb halogens or react with or provide catalytic reaction sites for the conversion of halogens to an ionic form for other reasons, for example, the removal of contaminants. These materials that may be placed in the filter for the purpose of adsorbing, absorbing, or converting halogens to ionic form, or, materials that are placed in the filter for another purpose but adsorb, absorb, or convert halogens to ionic form, are hereinafter collectively referred to as “halogen-scavenger barriers.” In these embodiments, halogen-scavenger barriers may be placed downstream of halogen-neutral barriers. In this manner, halogens remain in the fluid for an effective amount of time in order to maximize their antimicrobial effect before they are removed by halogen-scavenger barriers or before being dispensed from a filter or filter apparatus. The use of low residual halogenated resins may necessitate less free halogenated species being removed before dispensing the purified fluid. Indeed, it may even be possible to allow the halogens to remain in the fluid if the levels are high enough for adequate microbial kill but low enough to result in safe levels of halogens in the fluid and an aesthetically pleasing taste and/or scent of the purified fluid. Therefore, in certain embodiments, a filter or filter apparatus may require fewer or less effective halogen-scavenger barriers, or none at all.

The contaminant sorbent media comprising halogen-neutral media may include any material(s) known or unknown in the art that may be used to absorb or adsorb at least one contaminant and/or at least one halogen. Generally, but not always, absorption occurs through micropore size filtration, while adsorption occurs through electrochemical charge filtration. Such materials may include, but not limited to, organic or inorganic microfibers or microparticulates (such as glass, ceramic, wood, synthetic cloth fibers, metal fibers, polymeric fibers, nylon fibers, lyocell fibers, etc.); polymers; polymeric adsorbents; ionic or nonionic materials; ceramics; glass; cellulose; cellulose derivatives (such as cellulose phosphate or diethyl aminoethyl (DEAE) cellulose); fabrics such as rayon, nylon, cotton, wool or silk; metal; activated alumina; silica; zeolites; diatomaceous earth; clays; sediments; kaolin; sand; loam; activated bauxite, calcium hydroxyappatite; artificial or natural membranes; nano-ceramic based materials; nano-alumina fibers (such as NanoCeram® by Argonide—see, for example, U.S. Pat. No. 6,838,005, hereby incorporated by reference in its entirety, or Structured Matrix™ by General Ecology—see, for example, Gerba and Naranjo, Wilderness Env. Med., 11, 12-16 (2000), hereby incorporated by reference in its entirety; positively charged, titanium-based adsorbents for arsenic with nanocrystalline structures (titanium oxide nano-particles), such as Adsorbsia® by the Dow Chemical Corporation, as described in U.S. Pat. No. 6,919,029, hereby incorporated by reference in its entirety; lanthanum oxide media comprising a more positive charge than activated alumina over a wide pH range, as described in, for example, U.S. Pat. No. 5,603,838; highly reactive iron, including nanoiron media, as described in, for example, U.S. Patent Application No. 20060249465 filed on Mar. 15, 2006, hereby incorporated by reference in its entirety; coated diatomaceous earth, including materials containing hydronium ions, as described in Canadian Patent No. 2,504,703, hereby incorporated by reference in its entirety. Any of the examples of adsorbent and/or absorbent materials disclosed may be bound or enmeshed in a matrix of another material, thereby forming a combination material or membrane.

The contaminant sorbent media comprising halogen-scavenger barriers may include any material(s) known or unknown in the art that may be used to absorb or adsorb at least one contaminant and/or at least one halogen. Generally, but not always, absorption occurs through micropore size filtration, while adsorption occurs through electrochemical charge filtration. Such materials may include, for example, but are not limited to, carbon or activated carbon; ion exchange resins; including anion exchange resins and more particularly strong-base anion exchange resins such as Iodosorb®, a registered trademark of Water Security Corporation, Sparks, Nev., as described in U.S. Pat. No. 5,624,567, hereby incorporated by reference in its entirety.

Briefly, Iodosorb®, sometimes referred to as an iodine scrubber, comprises trialkyl amine groups each comprising from alkyl groups containing 3 to 8 carbon atoms which is capable of removing halogens, including iodine or iodide, from aqueous solutions.

In one example, nanosize electropositive fibers, such as NanoCeram®, described in U.S. Pat. No. 6,838,005, hereby incorporated by reference in its entirety, may be used as an adsorbent material, which utilizes electrokinetic forces to assist in trapping contaminants from the fluid. For example, if the electrostatic charges of the filter media and particulates or contaminants are opposite, the electrostatic attraction will facilitate the deposition and retention of the contaminants on the surface of the media. However, if the charges are similar, repulsion will occur. The surface charge of the filter is altered by changes in pH and the electrolyte concentration of the fluid being filtered. For example, lowering pH or adding cationic salts will reduce the electronegativity and allow for some adsorption to occur. Since most tap water has a pH range of between 5-9, the addition of acids and/or salts is often needed to remove viruses by electronegative filters.

Briefly, NanoCeram® fibers comprise highly electropositive aluminum hydroxide or alumina fibers approximately 2 nanometers in diameter and with surface areas ranging from 200 to 650 m²/g. When the NanoCeram® nanofibers are dispersed in water, they are able to attach to and retain electronegative particles and contaminants, including silica, organic matter, metals, DNA, bacteria, colloidal particles, viruses, and other debris. In addition to the fibers themselves, the fibers may be made into a secondary sorbent media by dispersing the fibers and/or adhering them to glass fibers and/or other fibers. The mixture may be processed to produce a nonwoven filter. Some of the characteristics of NanoCeram® include flow rates from ten to one hundred times greater than ultraporous membranes, with higher retention due to trapping by charge rather than size, endotoxin removal upwards of >99.96%, DNA removal upwards of >99.5% and filtration efficiency for micrometer-size particles upwards of >99.995%. NanoCeram® nanofibers by themselves may have a low iodine number, thought to be less than about 10 mg/g.

In addition, high surface area materials formed into fine microporous structures can be treated with a water-soluble high molecular weight cationic polymer and silver halide complex to obtain enhanced contaminant trapping and are considered in the present invention. (See, for example, Koslow, Water Cond. & Purif., 2004, hereby incorporated by reference in its entirety.) Such materials may be more resistant to changes in variable ionic strength (mono-, di- and trivalent ions), water temperature and pH. However, performance of this type of fibers may depend on the flow velocity of the filter apparatus, the contact time of the fluid with the fibers, the size of the pores of the filter media and the presence of a positive zeta potential (also called the electrokinetic potential).

Any of the examples of adsorbent and/or absorbent materials disclosed may be bound or enmeshed in a matrix of another material, thereby forming a combination material or membrane.

In at least one embodiment, the contaminant sorbent media comprises carbon and/or activated carbon. Activated carbon may comprise any shape or form (for example, it may be in pellets, granular, or powder form) and may be based on any acceptable origin, such as coal (especially lignite or bituminous), wood, sawdust, or coconut shells. Activated carbon may be certified for ANSI/NSF Standard 61 and ISO 9002 and/or satisfy the requirements of the U.S. Food Chemical Codex.

Activated carbon is an example of a halogen-scavenger barrier. Without being limited to any particular mechanism, activated carbon is believed to interact differently with chlorine, iodine, and bromine. Chlorine can react on the surface of activated carbon to form chloride ions. This mechanism is the basis for the removal of some common objectionable tastes and odors from drinking water due to chlorine. Through a different process it is well known that iodine is adsorbed onto the surface of activated carbon. Iodine is the most common standard adsorbate and is often used as a general measurement of carbon capacity. Because of its small molecular size, iodine more accurately defines the small pore or micropore volume of a carbon and thus reflects its ability to adsorb low molecular weight, small substances. The “iodine number” is defined as the milligrams of iodine adsorbed by one gram of carbon, and it approximates the internal surface area (square meters per gram). The iodine number of any particular activated carbon depends on many factors, but commonly ranges from 600 to 1300 mg/g.

Activated carbon may have absorptive and/or adsorptive properties, which may vary according to the carbon source. In general, the activated carbon surface is nonpolar which results in an affinity for nonpolar adsorbates, such as organic chemicals. All adsorptive properties rely on physical forces (such as Van der Waal's forces), with saturation represented by an equilibrium point. Due to the physical nature of the adsorptive properties, the process of adsorption is reversible (using heat, pressure, change in pH, etc.). Activated carbon is also capable of chemisorption, whereby a chemical reaction occurs at the carbon interface, changing the state of the adsorbate (for example, by dechlorination of water). In general, the adsorption capacity is proportional to the surface area (which is determined by the degree of activation) and lower temperatures generally increase the adsorption capacity (except in the case of viscous liquids). Likewise, adsorption capacity increases under pH conditions, which decrease the solubility of the adsorbate (normally lower pH). As with all adsorptive properties, sufficient contact time with the activated carbon is required to reach adsorption equilibrium and to maximize adsorption efficiency.

In at least one embodiment, one or more contaminant sorbent media comprises Universal Respirator Carbon (URC®), which is an impregnated granular activated carbon for multipurpose use in respirators or other fluid purification devices as described in U.S. Pat. No. 5,492,882, hereby incorporated by reference in its entirety. URC is composed of bituminous coal combined with suitable binders and produced under stringent conditions by high-temperature steam activation and impregnated with controlled compositions of copper, zinc, ammonium sulfate and ammonium dimolybdate (no chromium is used so disposal is simple).

In one embodiment, KX carbon may be used as one or more types of contaminant sorbent media. KX carbon is a mixture of carbon and Kevlar® that is moldable and able to trap or retain contaminants from fluids as the fluid passes over its surface. Another contaminant sorbent media that may be used with devices or apparatuses disclosed herein includes General Ecology® carbon, which includes a proprietary “structured matrix.”

In at least one aspect, the activated carbon or activated alumina is impregnated with another agent. In at least one aspect, the activated carbon is not impregnated with any other agent. Some suitable agents include sulfuric acid, molybdenum, triethylenediamine, copper, zinc, ammonium sulfate, cobalt, chromium, silver, vanadium, ammonium dimolybdate, Kevlar®, or others, or any combination thereof. These examples of activated carbon used in filtration systems are described in U.S. Pat. Nos. 3,355,317; 2,920,050; 5,714,126; 5,063,196 and 5,492,882, hereby incorporated by reference in their entirety.

Halogenated Resins

As will be described herein, in certain embodiments, the present disclosure provides a multi-barrier filter comprising at least one halogenated resin, and at least one contaminant sorbent medium downstream of the halogenated resin capable of adsorbing or absorbing contaminants. Since halogens, and particularly chlorine and iodine, function efficiently as antimicrobial agents, it is desirable to include one or more halogenated resins in fluid purification media. The halogens are released from the halogenated resins and into the fluid until they are removed or until the fluid exits the filter.

The present invention further relates to halogenated resins. In at least one embodiment, the halogenated resin comprises chlorine, bromine or iodine. In at least one embodiment, the halogenated resin comprises an iodinated resin. In at least one embodiment, the halogenated resin comprises a “low-residual” resin such as a low-residual iodinated resin.

In at least one embodiment, the iodinated resin comprises a Microbial Check Valve or MCV® Resin. Briefly, the MCV® Resin has been used by NASA aboard space shuttle flights since the 1970s. The MCV® Resin contains an iodinated strong base ion exchange resin of polyiodide anions bound to the quaternary amine fixed positive charges of a polystyrene-divinylbenzene copolymer. Polyiodide anions are formed in the presence of excess iodine in an aqueous solution, and accordingly, bound polyiodide anions release iodine into the water. Water flowing through the MCV® Resin achieves a microbial kill as well as residual iodine ranging between about 0.5-4.0 mg/L, which decreases the buildup of biofilm in storage and/or dispensing units.

MCV® Resin consistently kills over 99.9999% of bacteria (log 6 kill) and 99.99% of viruses (log 4 kill) found in contaminated water. In addition, a replacement cartridge, called regenerative MCV (RMCV) has been developed. The RMCV utilizes a packed bed of crystalline elemental iodine to produce a saturated aqueous solution that is used to replenish depleted MCV® Resin. Tests have shown the RMCV can be regenerated more than 100 times. The use of a regenerative system reduces the overall cost of operating an iodine delivery system and eliminates the hazards associated with chlorine.

Thus, in at least one embodiment, the filter media of the present invention comprises one or more halogenated resins and one or more contaminant sorbent media wherein at least one of the contaminant sorbent media comprises carbon, and the at least one of the halogenated resins comprises an iodinated resin (such as MCV®). In at least one embodiment, the filter media further comprises an anion exchange base resin (such as Iodosorb®). In at least one embodiment, the filter media further comprises nano-alumina fibers (such as NanoCeram®).

There are many known methods for making halogenated resins, including iodinated resins. For example, U.S. Pat. Nos. 5,980,827; 6,899,868 and 6,696,055, all of which are hereby incorporated by reference in their entirety, include methods of making halogenated or strong base anion exchange resins for purification of fluids such as air and water. Briefly, examples of making iodinated resins include reacting a porous strong base anion exchange resin in a salt form with a sufficient amount of an iodine substance absorbable by the anion exchange resin such that the anion exchange resin absorbs the iodine substance and converts the anion exchange resin to an iodinated resin. If necessary, the iodinated resin reaction may be conducted in an elevated temperature and/or elevated pressure environment.

As one of skill in the art will recognize, the halogen release from the resin may be dependent on eluent pH, temperature and flow rate, as well as the characteristics of the fluid (such as the level of contamination, including the amount of total dissolved solids or sediment, etc.), but much less so than traditional filters. As used herein, generally the phrase “low residual” halogenated resin has a significantly lower level of halogen release than a “classic” halogenated resin. In one example, with deionized water, iodine release from a “classic” resin is approximately 4 ppm. According to certain embodiments, the iodine released from a low residual iodinated resin may be less than 4 ppm. In other embodiments, the iodine released from a low residual iodinated resin may be between 0.1 and 2 ppm. In still other embodiments, the iodine released from a low residual iodinated resin may be between 0.2 and 1 ppm. In certain other embodiments, the iodine released from a low residual iodinated resin may be between 1 ppm and 0.5 ppm. In further embodiments, the iodine released from a low residual iodinated resin may be between 0.5 ppm and 0.2 ppm or less. In still further embodiments, the iodine released from a low residual iodinated resin may be 0.2 ppm or less.

According to certain embodiments, the present disclosure includes a multi-barrier filter. In certain embodiments, the filter comprises a halogenated resin capable of removing contaminants from a fluid, and at least one contaminant sorbent medium downstream of the halogenated resin capable of adsorbing or absorbing contaminants. In at least one embodiment, the at least one contaminant sorbent medium may have an iodine number less than 300 mg/g. In other embodiments, contaminants comprise microorganisms and microbes.

Other embodiments of the multi-barrier filter comprise a halogenated resin comprising at least one resin selected from the group consisting of low residual halogenated resins, iodinated resins, low residual iodinated resins, chlorinated resins, and brominated resins. Other embodiments of the multi-barrier filter comprise a halogenated resin comprising two or more resins selected from the group consisting of low residual halogenated resins, iodinated resins, low residual iodinated resins, chlorinated resins, and brominated resins. In still other embodiments, the halogenated resin comprises an iodinated base ion exchange resin of polyiodide anions bound to the quaternary amine fixed charges of a polymer.

In other embodiments of the multi-barrier filter of the present disclosure, the contaminant sorbent medium comprises at least one sorbent medium selected from the group consisting of nano-alumina fibers and ceramic material. In still other embodiments, the contaminant sorbent medium comprises nano-alumina fibers having a diameter of approximately 2 nanometers and a surface area in the range of 200 m²/gram to 650 m²/gram.

According to further embodiments, the contaminant sorbent medium comprises at least one sorbent medium selected from the group consisting of organic or inorganic microfibers or microparticles, polymers, polymeric adsorbants, nonionic materials, fabrics, rayon, nylon, cotton, wool, silk, metal, activated alumina, silica, zeolites, diatomaceous earth, clays sediments, kaolin, sand, loam, activated bauxite, calcium hydroxyappatite, artificial or natural membranes, nano-alumina fibers, titanium oxide nano-particles, lanthanum oxide media, highly reactive iron/nano-iron media, and coated diatomaceous earth. Further embodiments comprise a contaminant sorbent medium comprising nano-alumina fibers selected from the group consisting of electropositive nano-alumina fibers and impregnated alumina.

In certain embodiments of the multi-barrier filter of the present disclosure, the filter may be configured to receive a fluid such that the fluid contacts the halogenated resin prior to contacting a contaminant sorbent medium.

According to certain embodiments of the present disclosure, the multi-barrier filter comprises a contaminant sorbent medium comprising nano-alumina fibers, and the halogenated resin comprises an iodinated resin. According to other embodiments of the multi-barrier filter, the fluid may comprise a gas, a vapor, or a liquid. In still other embodiments, the fluid is selected from the group consisting of a bodily fluid, urine, and water.

According to one embodiment, the multi-barrier filter comprises a halogenated resin capable of removing contaminants from a fluid and at least one halogen-neutral contaminant sorbent medium downstream of the halogenated resin capable of adsorbing or absorbing contaminants. In this embodiment, the at least one contaminant sorbent medium may have an iodine number less than 300 mg/g. The filter may also comprise at least one halogen-scavenger contaminant sorbent medium downstream of the halogen-neutral media. The contaminants comprise microorganisms and microbes.

According to other embodiments, the halogenated resin comprises an iodinated resin, the at least one halogen-neutral contaminant sorbent media comprises nano-alumina fibers, and the at least one halogen-scavenger media comprises activated carbon. In further embodiments, the at least one halogen-scavenger media comprises activated carbon and an anion exchange base resin (such as Iodosorb®).

Apparatus and/or System Housings

The present invention also relates to apparatuses and systems for removing contaminants from fluids. The “multi-barrier” filter media, apparatuses and systems of the present invention may be implemented by combining media components and functions in a single device or by using several separate devices in series or in parallel where each performs a distinct function or functions. In certain aspects, the filter media is contained within a housing or cartridge. The housing or cartridge may be made of any known compositions typically used for such fluid purification devices. In particular, the housing may comprise plastic (including polyethylene, polyvinyl carbonate, polypropylene, polystyrene, etc.), wood, metal (including stainless steel), fabric, glass, silicone, fibers (woven or nonwoven), polymers (such as polyvinylidene difluoride (PVDF), polyolefin, acrylics, or silicone) or any combination thereof. In addition, the housing may be coated on any surface with one or more agents, including antimicrobial agents (including antibacterial or antifungal agents); polytetrafluoroethylene (Teflon®)); polymers (such as silicone); plastics; or other agents.

In certain aspects, the fluid purification media may be disposable, while the outer housing is reused with new replacement media. In other aspects, both the fluid purification media and the housing itself may be disposable or reusable. It is understood that any embodiment disclosed herein may be fully disposable or reusable, or certain specific components may be disposable while other components are reusable, depending on the purification goals and/or ease of manufacture of necessary components as well as the ability to maintain purified fluid with any reused components. In certain aspects, the present invention relates to an apparatus for removing contaminants from a fluid. In at least one embodiment, the apparatus comprises an inlet port, an outlet port, one or more halogenated resins and one or more contaminant sorbent media. In at least one embodiment, the inlet port and outlet port define the fluid path such that the fluid passing through the filter media flows in a unilateral direction.

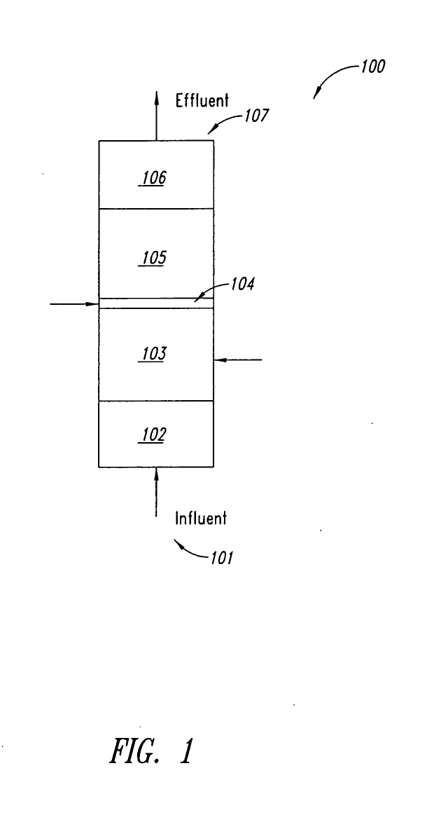

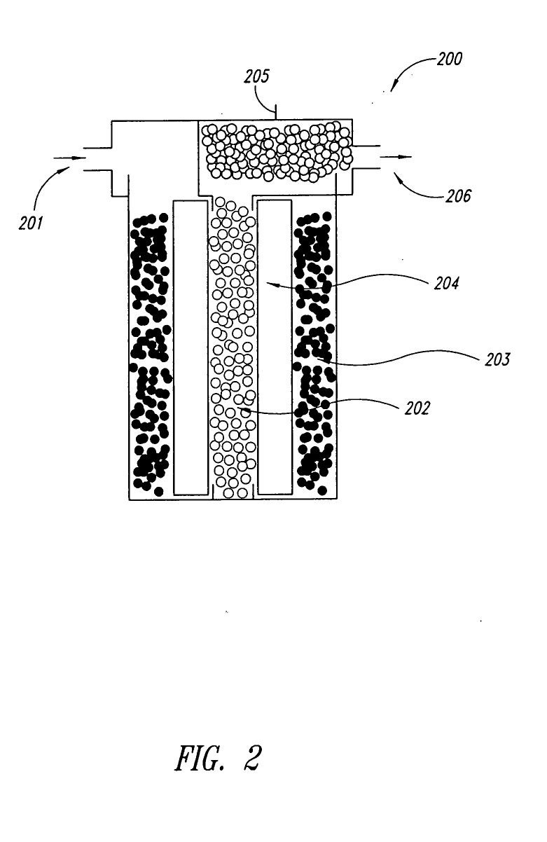

FIGS. 1, 2 and 7 show illustrated embodiments of the present fluid purification device 100, 200, 700, respectively, wherein fluid passes into the influent opening of the apparatus 101, 201, 701, respectively, and through the filter media with at least some of the purified fluid emerging from the effluent opening 107, 206, 707, respectively.

In at least one embodiment, the filter media comprises one or more contaminant sorbent media 102, 104-106, 202, 204, 205, 702, 704-706. In one illustrated embodiment, at least one contaminant sorbent media comprises granular activated carbon 102, 106, 205, 702, 706. In at least one illustrated embodiment, at least one contaminant sorbent media comprises bituminous coal-based granular activated carbon 702. In one illustrated embodiment, at least one contaminant sorbent media comprises a nano-ceramic material, such as NanoCeram® 104, 204, 705. In one illustrated embodiment, at least one contaminant sorbent media comprises a halogen-removing media, such as Iodosorb® 105, 202, 704. In at least one embodiment, the fluid filter media comprises one or more halogenated resins. In one illustrated embodiment, at least one halogenated resin is an iodinated resin, such as Microbial Check Valve Resin 103, 203, 703. In at least one embodiment, at least one contaminant sorbent media comprises Argonide NanoCeram®, KX carbon, or General Ecology® carbon.

The filtration media may be formed into any shape or format, including a sheet, film, block, or accordion-style or fan-style cartridge. The media components may be housed in standard conventional housing, or shaped into any other desired format to satisfy the fluid purification goals. In addition, one of skill in the art would understand that the micropore size and physical dimensions of the media may be altered for the desired applications and other variations such as flow rates, back-pressure, contact time of fluid with filter media, level of filtration needed, etc. In addition, if the media components are in a self-contained unit, the components may be separated by chambers or walls comprising any material listed herein for the external housing, or another material. The media components may be horizontally or vertically stacked within the device, arranged concentrically, or arranged in any other fashion.

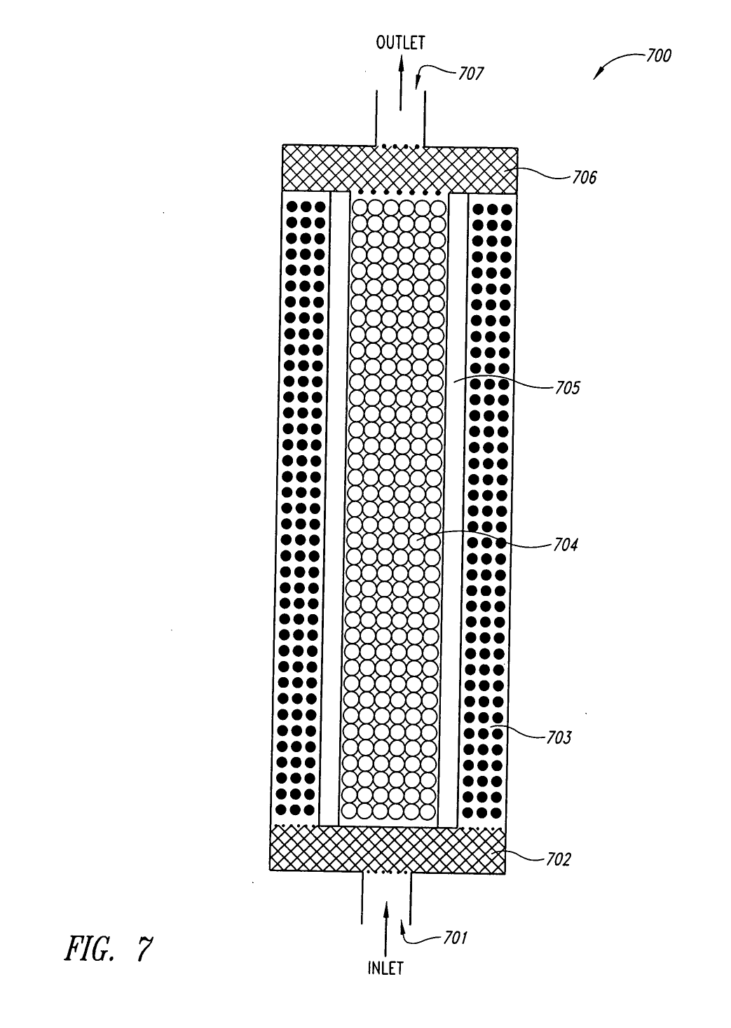

As indicated in FIG. 7, one embodiment includes an apparatus for which the “multi-barrier” fluid purification media is arranged concentrically within the apparatus housing. As the fluid passes through the multiple layers of contaminant sorbent media (such as various layers of granulated carbon, iodinated resin, and iodine scrubber) a large surface area is available for removing and/or rendering harmless any contaminants present in the fluid. For certain embodiments, it is advantageous to efficiently use space and have a large surface area available for fluid purification contained within a relatively small housing. Thus, arranging the fluid purification media in spirals, concentric circles, or zig-zag fan formats may provide efficient fluid purification within a small housing that may be convenient for portable purification devices or systems or other circumstances that warrant an efficient use of space.

In certain aspects, one or more halogen-neutral filter media materials comprise a microporous structure. As one of skill in the art appreciates, micropore size is measured according to the diameter of the particulate or contaminant that the media can efficiently and consistently trap. Micropore size is defined as nominal or absolute. Nominal pore size rating describes the ability of the filter to retain the majority of the particles at the rated pore size and larger (60-90%), whereas absolute pore size rating describes the pore size at which a challenge organism of a particular size will be retained with 99.9% efficiency under strictly defined test conditions.

In certain aspects, the microporous filter has an absolute pore rating in the range from about 50 micrometers to about 200 micrometers. In certain embodiments, the microporous filter has an absolute pore rating in the range from about 10 micrometers to about 50 micrometers. In certain aspects, the microporous filter has an absolute pore rating in the range of about 1 micrometer to about 10 micrometers. In certain aspects, the microporous filter has an absolute pore rating in the range of about 0.01 micrometer to about 1.0 micrometer. As one of skill in the art would appreciate, multiple materials used in a filter media may have different pore sizes or the same pore size.

In certain aspects, the microporous structure has a mean flow path of less than about 5 micrometers, less than about 4 micrometers, less than about 3 micrometers, less than about 2 micrometers, less than about 1 micrometer or any value therebetween. In certain aspects, the microporous structure has a mean flow path of less than about 0.9 micrometers, 0.8 micrometers, 0.7 micrometers, 0.6 micrometers, 0.5 micrometers, 0.4 micrometers, 0.3 micrometers, 0.2 micrometers, 0.1 micrometers or any value less than or there between.

In certain aspects, the present invention relates to an apparatus comprising a filter media comprising one or more halogenated resins and one or more contaminant sorbent media. In certain embodiments, it may be desirable to increase the efficiency of the filter media by increasing the surface area of one or more media components and/or increase the amount of time the fluid is in contact with one or more media components. Increasing the surface area and/or contact time with the fluid may be accomplished by increasing the format (such as making the layers a spiral, accordion-style, pleats or other multilayer format) and/or increasing the number of layers for each filter media component, and/or increasing the number of types of different media components, or any combination thereof.

In certain aspects, the present invention may be a point-of-use (POU) fluid or point-of-entry (POE) treatment apparatus or system. POU/POE fluid treatment, including water purification, usually comprises a self-contained unit that can be used by anyone who would ordinarily get water from untreated sources (such as lakes, rivers and streams), although it can also be used for further treatment of tap water as a countertop, refrigerator or other unit. POU/POE treatment is important for campers, hikers, military personnel, for use in emergency situations such as earthquakes, hurricanes and floods, as well as for people living in rural or sparsely populated regions (including those living in non-industrialized nations) who may not have access to treated or purified water.

In certain aspects, substantially all of the components of the filter media of the present invention are contained within a single housing unit (see FIGS. 1, 2, 7). In at least one embodiment, the apparatus is operated entirely by the user. For example, the apparatus may comprise a portable purification device that utilizes external force delivered by a handheld pump or vacuum pressure drawn by the user sucking on a tube conduit or “drinking straw” 100, 700 style to draw fluid into and through the purification device. Some examples of such formats for water purification devices may be found in U.S. Pat. Nos. 4,828,698 and 4,995,976. Briefly, an example of this type of water purification device includes a self-contained purification unit with a generally cylindrical filter arrangement which is disposed within the housing in the liquid flow path and a microfibrous filter that removes contaminants from the fluid as it flows through the filter. However, the present “drinking straw” style filters suffer from an inadequate removal of certain microbial contaminants.

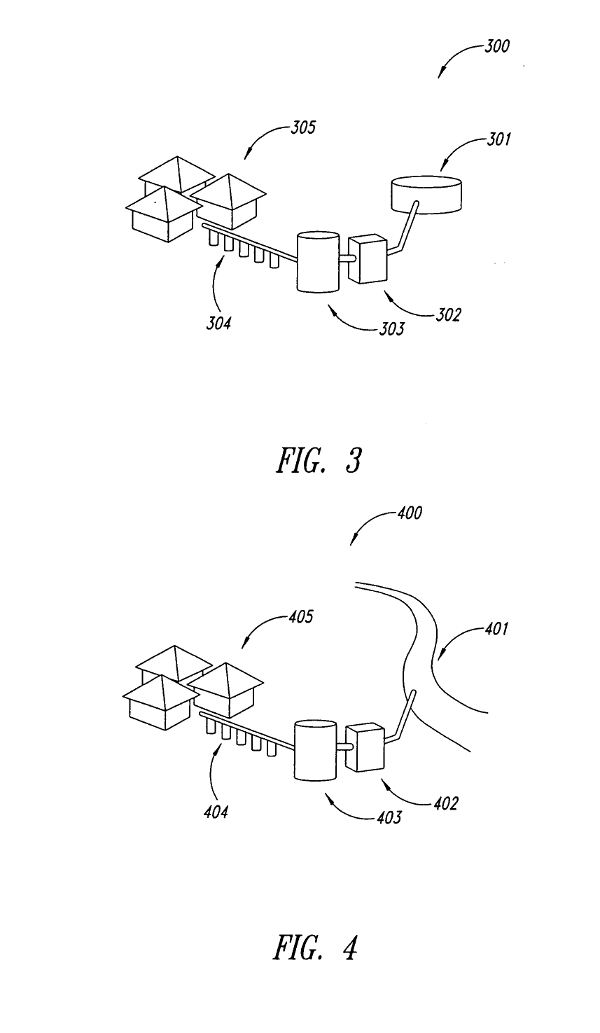

In certain aspects, the invention relates to a filtration system for purifying, storing and/or dispensing fluids comprising a filter media as described herein, a reservoir in fluid communication with the filter media for collecting the purified fluid, and a means for dispensing the purified fluid. (See FIGS. 3, 4). In at least one embodiment, the invention further comprises an additional reservoir for holding the fluid prior to purification, wherein the reservoir may or may not be in constant fluid communication with the filter media used to purify the fluid. Thus, in certain aspects of the invention the filtration system may comprise a first reservoir for holding the fluid desired to be purified, a filter media comprising one or more halogenated resins and one or more contaminant sorbent media, a second reservoir for holding the purified fluid and, optionally, a means for dispensing the purified fluid.

FIGS. 3 and 4 illustrate certain embodiments of fluid purification systems 300, 400, respectively, wherein unpurified or contaminated fluid, such as water, is transported by conduit from a well or storage vessel 301 or from a surface water source, such as a river 401. The water is then treated or purified by the fluid purification apparatus or system 302, 402, and optionally transported to a storage tank 303, 403 before subsequently being dispensed 304, 404 by conduit to the consumer 305, 405.

The capacity of the reservoir may be dependent or independent of the filtering capacity of the filter media. Thus, in certain embodiments a small reservoir tank may be sufficient (such as for a portable water purification system), whereas in other certain embodiments a larger reservoir tank is needed (such as for storing purified water for a village or community). In certain aspects, the storage tank may be transported subsequent to filling and prior to purifying the fluid and/or subsequent to purifying the fluid and prior to dispensing the fluid.

Other embodiments of the present disclosure include a filter apparatus for removing contaminants from a fluid. An embodiment of the filter apparatus comprises a housing comprising one or more inlet ports and one or more outlet ports, a halogenated resin capable of removing contaminants, and at least one contaminant sorbent medium downstream of the halogenated resin capable of adsorbing or absorbing contaminants. In these embodiments, the at least one contaminant sorbent medium has an iodine number less than 300 mg/g. In other embodiments of the filter apparatus, the contaminants comprise microorganisms and microbes.

According to other embodiments of the filter apparatus, the halogenated resin is selected from the group consisting of low residual halogenated resins, iodinated resins, low residual iodinated resins, chlorinated resins, and brominated resins.

In certain embodiments of the filter apparatus of the present disclosure, the contaminant sorbent medium comprises at least one sorbent medium selected from the group consisting of nano-alumina fibers and ceramic material. According to other embodiments, the contaminant sorbent medium comprises nano-alumina fibers having a diameter of approximately 2 nanometers and a surface area in the range of 200 m²/gram to 650 m²/gram. In still other embodiments, the contaminant sorbent medium comprises at least one sorbent medium selected from the group consisting of organic or inorganic microfibers or microparticles, polymers, polymeric adsorbants, non-ionic materials, fabrics, rayon, nylon, cotton, wool, silk, metal, activated alumina, silica, zeolites, diatomaceous earth, clays sediments, kaolin, sand, loam, activated bauxite, calcium hydroxyappatite, artificial or natural membranes, nano-alumina fibers, titanium oxide nano particles, lanthanum oxide media, highly reactive iron/nano-iron media, and coated diatomaceous earth. Further embodiments comprise a contaminant sorbent medium comprising nano-alumina fibers selected from the group consisting of electropositive nano-alumina fibers and impregnated alumina.

In other embodiments of the filter apparatus of the present disclosure, the filter apparatus may be configured to receive a fluid through the inlet port such that the fluid contacts the halogenated resin prior to contacting the contaminant sorbent medium and exiting the outlet port.

Methods

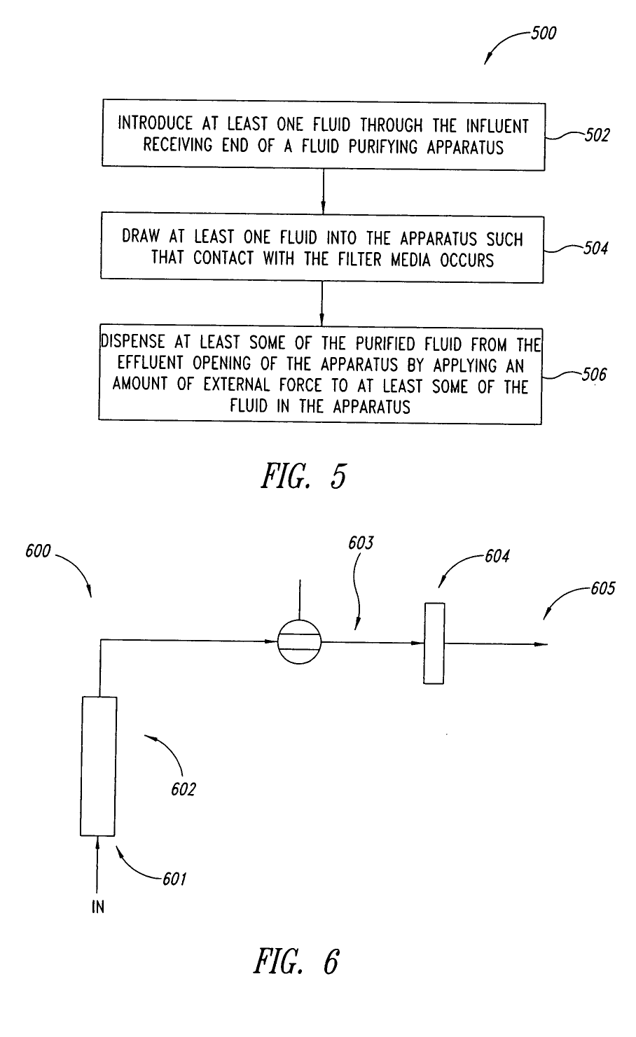

The method 500 depicted in FIG. 5 begins by introducing at least one fluid to be purified to the influent receiving end of the apparatus 502. The at least one fluid is drawn into the apparatus and contacts the filter media 504. In another embodiment, the fluid is drawn into the apparatus by applying an amount of external force. The external force may be due to the natural pressure of the fluid or surrounding the fluid, or it may be a pressure applied to the fluid, such as by vacuum. The external force may be any combination of forces, including mechanical, electrical, or thermally applied external force that operates to direct the fluid toward the effluent opening of the apparatus. Finally, at least some of the purified fluid is dispensed from the effluent opening of the apparatus by applying an amount of external force to at least some of the fluid in the apparatus.

For example, the external force applied to the fluid within the apparatus or system may result from use of a hand-held pump, an electric pump, a mechanical pump, a peristaltic pump or it may include pressure generated by the user's capacity to draw in or blow out by mouth the fluid within the apparatus.

Kits

The present invention further provides kits relating to any of the compositions, apparatuses, systems and/or methods described herein.

### EXAMPLES

The following examples are provided as a further illustration and not any limitation of the present invention. The teachings of all references, patents and published patent applications cited throughout this application, as well as the Figures, are hereby incorporated by reference.

### Example 1

A fluid filter system representing one embodiment of the present invention 600 (see FIG. 6) was tested for its ability to remove contaminants from an unpurified fluid. In particular, unpurified water was introduced to the influent opening 601 of the system and contacted with a MCV® iodinated resin column 602 (approximately 5.5 mL) and subsequently passed through a NanoCeram® nano-alumina fiber material 604, and dispensed through the effluent opening 605. Testing for contaminants was conducted following contact with the MCV® column, at site 603, as well as following the NanoCeram® material, at site 605. The flow-through the system was upstream at 20 mL/min. The results of the testing are shown in TABLE 1 and TABLE 2, where no detectable breakthrough of MS2 or E.coli contaminants occurred. SP1 indicates testing at site 603, while SP2 indicates testing at site 605.

TABLE 1
MCV + Argonide: E-coli 20 mL/min @pH ˜8.0: t = 21°-25° C.

| | | |
|---|---|---|
| | Result | Log₁₀ |
| Sample | (cfu/100 mL) | Inactivation |

1st DAY

| | | |
|---|---|---|
| Influent | 3.00E+06 | |
| SP₁ 35 min (0.70 L) | <1 | >6.48 |
| SP₂ 35 min (0.70 L) | <1 | >6.48 |
| SP₁ 2.5 h (3.00 L) | <1 | >6.48 |
| SP₂ 2.5 h (3.00 L) | <1 | >6.48 |
| SP₁ 5.0 h (6.00 L) | <1 | >6.48 |
| SP₂ 5.0 h (6.00 L) | <1 | >6.48 |

2nd DAY

| | | |
|---|---|---|
| Influent | 4.50E+07 | |
| SP₁ 7.0 h (8.40 L) | 51 | 5.95 |
| SP₂ 7.0 h (8.40 L) | <1 | >7.65 |
| SP₁ 8.5 h (10.2 L) | 35 | 6.11 |
| SP₂ 8.5 h (10.2 L) | <1 | >7.65 |
| SP₁ 9.5 h (11.4 L) | 31 | 6.16 |
| SP₂ 9.5 h (11.4 L) | <1 | >7.65 |

TABLE 2
MCV + Argonide: MS2 20 mL/min @pH ˜8.0: t = 21°-25° C.

| | | |
|---|---|---|
| | Result | Log₁₀ |
| Sample | (pfu/mL) | Inactivation |

1st DAY

| | | |
|---|---|---|
| Influent | 3.00E+04 | |
| SP₁ 35 min (0.70 L) | <1 | >4.48 |
| SP₂ 35 min (0.70 L) | <1 | >4.48 |
| SP₁ 2.5 h (3.00 L) | <1 | >4.48 |
| SP₂ 2.5 h (3.00 L) | <1 | >4.48 |
| SP₁ 5.0 h (6.00 L) | <1 | >4.48 |
| SP₂ 5.0 h (6.00 L) | <1 | >4.48 |

2nd DAY

| | | |
|---|---|---|
| Influent | 4.50E+04 | |
| SP₁ 7.0 h (8.40 L) | <1 | >4.88 |
| SP₂ 7.0 h (8.40 L) | <1 | >4.88 |
| SP₁ 8.5 h (10.2 L) | <1 | >4.88 |
| SP₂ 8.5 h (10.2 L) | <1 | >4.88 |
| SP₁ 9.5 h (11.4 L) | <1 | >4.88 |
| SP₂ 9.5 h (11.4 L) | <1 | >4.88 |

### Example 2

In a separate test conducted with Argonide filter alone, breakthrough of both MS2 and E.coli occurred after approximately 2.75 liters of water passed through the single filter apparatus. Results of the Argonide filter test alone are shown in TABLE 3 and TABLE 4.

TABLE 3
Argonide Filter Alone: E. coli 10 mL/min:
pH ˜8.0: t = 21°-25° C.

| | Result | Log₁₀ |
|---|---|---|
| Sample | (cfu/100 mL) | Inactivation |
| Influent | 3.00E+06 | |
| E. coli 4.6 h (2.76 L) | 48 | 4.80 |

TABLE 4
Argonide Filter Alone: MS2 10 mL/min: pH ˜8.0: t = 21°-25° C.

| | Result | Log₁₀ |
|---|---|---|
| Sample | (pfu/mL) | Inactivation |
| Influent | 3.00E+04 | |
| MS2 4.6 h (2.76 L) | 40 | 2.88 |

### Example 3

A manifold similar to the one depicted in FIG. 6 was utilized for these tests. However, 20 mL of LR-1 iodinated resin was used instead of 5.5 mL of “classic” MCV.

Table 5 summarizes microbiological inactivation data as a function of the barrier(s) used (LR-1→low residual iodinated resin; Membrane→NanoCeram® Argonide; LR-1+Membrane→in-series combination of the two barriers).

TABLE 5
Klebsiella terrigena Inactivation (pH 7 ± 0.1; t = 20 ± 1° C.)

| | Log₁₀ Inactivation | | |
|---|---|---|---|
| Sample | LR-1 | Membrane | LR-1 + Membrane |
| 50 mL/min | 7.15 | 6.88 | >7.15 |
| 100 mL/min | 4.94 | 5.32 | >7.15 |
| 150 mL/min | 1.95 | 4.48 | >7.15 |

Influent (cfu/L): 1.40 × 10⁸-1.51 × 10⁸

Table 6 compares inactivation of MS2 obtained with LR-1/Membrane combination as well as membrane and LR-1 each by itself as a function of challenge solution flow rates.

TABLE 6
MS2 Inactivation (pH 7 ± 0.1; t = 20 ± 1° C.)

| | Log₁₀ Inactivation | | |
|---|---|---|---|
| Sample | LR-1 | Membrane | LR-1 + Membrane |
| 50 mL/min | 1.92 | 3.55 | >5.67 |
| 100 mL/min | 1.18 | 3.05 | 3.92 |
| 150 mL/min | 0.93 | 1.91 | 3.07 |

Influent (pfu/L): 8.95 × 10⁷-1.17 × 10⁸

### Example 4

In another embodiment, as indicated in FIG. 7, contaminated water enters through an inlet port, and passes through the bituminous-based GAC. This first GAC bed is able to absorb, among other things, iodine-oxidizable organic species that may be present in the influent water.

After passing through the GAC, the water continues through the mesh screens placed concentrically on the “outside” part of the cylinder. The water then comes in contact with (LR-1) MCV resin that is packed outside the bacteria/virus adsorbing cartridge (e.g., Argonide NanoCeram® material, new KX carbon, General Ecology carbon, etc.). The water also passes through a sorptive surface, for example, NanoCeram®), as it travels through the filter. Microbes and/or cysts that are not killed by the action of the iodinated resin are retained on the sorptive surface.

Equivalents

Those skilled in the art will recognize, or be able to ascertain using no more than routine experimentation, numerous equivalents to the specific method and reagents described herein, including alternatives, variants, additions, deletions, modifications and substitutions. Such equivalents are considered to be within the scope of this invention and are covered by the following claims.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

We claim:

1. A multi-barrier filter, comprising:
a halogenated resin capable of removing contaminants from a fluid; and
at least one contaminant sorbent medium downstream of the halogenated resin capable of adsorbing or absorbing contaminants, wherein the at least one contaminant sorbent medium has an iodine number less than 300 mg/g.

2. The multi-barrier filter of claim 1, wherein the contaminants comprise microorganisms and microbes.

3. The multi-barrier filter of claim 1, wherein the halogenated resin comprises at least one resin selected from the group consisting of low residual halogenated resins, iodinated resins, low residual iodinated resins, chlorinated resins, and brominated resins.

4. The multi-barrier filter of claim 3, wherein the halogenated resin comprises two or more resins selected from the group consisting of low residual halogenated resins, iodinated resins, low residual iodinated resins, chlorinated resins, and brominated resins.

5. The multi-barrier filter of claim 1, wherein the halogenated resin comprises an iodinated base ion exchange resin of polyiodide anions bound to the quaternary amine fixed charges of a polymer.

6. The multi-barrier filter of claim 1, wherein the contaminant sorbent medium comprises at least one sorbent medium selected from the group consisting of nano-alumina fibers and ceramic medium.

7. The multi-barrier filter of claim 6, wherein the contaminant sorbent medium comprises nano-alumina fibers having a diameter of approximately 2 nanometers and a surface area in the range of 200 m²/gram to 650 m²/gram.

8. The multi-barrier filter of claim 1, wherein the contaminant sorbent medium comprises at least one sorbent medium selected from the group consisting of organic or inorganic microfibers or microparticles, polymers, polymeric adsorbants, non-ionic mediums, fabrics, rayon, nylon, cotton, wool, silk, metal, activated alumina, silica, zeolites, diatomaceous earth, clays sediments, kaolin, sand, loam, activated bauxite, calcium hydroxyappatite, artificial or natural membranes, nano-alumina fibers, titanium oxide nano particles, lanthanum oxide media, highly reactive iron/nano-iron media, and coated diatomaceous earth.

9. The multi-barrier filter of claim 1, wherein the contaminant sorbent medium comprises a nano-alumina fiber selected from the group consisting of electropositive nano-alumina fibers and impregnated alumina.

10. The multi-barrier filter of claim 1, wherein the multi-barrier filter is configured to receive a fluid such that the fluid contacts the halogenated resin prior to contacting the contaminant sorbent medium.

11. The multi-barrier filter of claim 10, wherein the contaminant sorbent medium comprises nano-alumina fibers and the halogenated resin comprises an iodinated resin.

12. The multi-barrier filter of claim 11, wherein the fluid is a gas, vapor, or liquid.

13. The multi-barrier filter of claim 11, wherein fluid comprises a liquid selected from the group consisting of a bodily fluid, urine, and water.

14. A filter apparatus for removing contaminants from a fluid, comprising:
a housing comprising one or more inlet ports and one or more outlet ports;
a halogenated resin capable of removing contaminants; and
at least one contaminant sorbent medium downstream of the halogenated resin capable of adsorbing or absorbing contaminants, wherein the at least one contaminant sorbent medium has an iodine number less than 300 mg/g.

15. The filter apparatus of claim 14, wherein the contaminants comprise microorganisms and microbes.

16. The filter apparatus of claim 14, wherein the halogenated resin comprises at least one resin selected from the group consisting of low residual halogenated resins, iodinated resins, low residual iodinated resins, chlorinated resins, and brominated resins.

17. The filter apparatus of claim 14, wherein the contaminant sorbent medium comprises at least one sorbent medium selected from the group consisting of nano-alumina fibers and ceramic medium.

18. The filter apparatus of claim 17, wherein the contaminant sorbent medium comprises nano-alumina fibers having a diameter of approximately 2 nanometers and a surface area in the range of 200 m²/gram to 650 m²/gram.

19. The multi-barrier filter of claim 14, wherein the contaminant sorbent medium comprises at least one sorbent medium selected from the group consisting of organic or inorganic microfibers or microparticles, polymers, polymeric adsorbants, non-ionic mediums, fabrics, rayon, nylon, cotton, wool, silk, metal, activated alumina, silica, zeolites, diatomaceous earth, clays sediments, kaolin, sand, loam, activated bauxite, calcium hydroxyappatite, artificial or natural membranes, nano-alumina fibers, titanium oxide nano particles, lanthanum oxide media, highly reactive iron/nano-iron media, and coated diatomaceous earth.

20. The filter apparatus of claim 14, wherein the filter apparatus is configured to receive a fluid through the inlet port such that the fluid contacts the halogenated resin prior to contacting the contaminant sorbent medium and exiting the outlet port.
